(19) United States
(12) Patent Application Publication
(10) Pub. No.: US 2026/0174623 A1
(43) Pub. Date: Jun. 25, 2026

(54) MASSAGE DEVICE

(71) Applicant: Dongguan Pinchen Industrial Design Co., Ltd., Dongguan (CN)

(72) Inventor: Yinyuan Li, Dongguan (CN)

(21) Appl. No.: 19/405,437

(22) Filed: Dec. 2, 2025

(30) Foreign Application Priority Data
Dec. 20, 2024 (CN) 202423167888.6

(51) Int. Cl. A61H 19/00; A61H 23/02

(52) U.S. Cl. CPC A61H 19/50; A61H 19/32; A61H 19/34; A61H 19/44; A61H 23/0254; A61H 2201/165; A61H 2201/1671; A61H 2201/1676

(57) ABSTRACT

A massage device includes a main body, a massage portion being provided at an end of the main body, a driving mechanism being mounted in the main body, and a fixing portion extending from the main body. The fixing portion is configured for positioning the massage device onto a penis of a human body. The massage portion is configured to be inserted into another human body, and the driving mechanism is configured for driving the massage portion to rotate/swing, so as to stimulate a part of the another human body in which the massage portion is inserted.

### CROSS-REFERENCE TO RELATED APPLICATIONS

This application claims priority of Chinese Patent Application No. 202423167888.6, filed on Dec. 20, 2024, the entire contents of which are hereby incorporated by reference.

### TECHNICAL FIELD

The present application relates to the technical field of adult products, and in particular to a massage device.

### BACKGROUND

In recent years, various adult products have been developed to help users enhance their sexual experience. Conventional massage devices, such as love eggs, are generally mechanical vibration devices. These devices provide high-frequency vibrations to stimulate sensitive parts of the human body, such as the nipples, the vagina, the penis, and etc., which cause strong discomfort and result in poor user experience.

### SUMMARY

An object of the present application is to provide a massage device which can provide better stimulation effect and sexual experiences.

In order to achieve the above object, an embodiment of the present application provides a massage device, including: a main body; a massage portion being provided at an end of the main body, the massage portion being configured to be inserted into a human body; a driving mechanism being mounted in the main body, configured for driving the massage portion to rotate/swing, so as to stimulate a part of the human body in which the massage portion is inserted; and a fixing portion extending from the main body, configured for positioning the massage device onto a penis of another human body.

Compared with the prior art, the above massage device may be positioned onto the penis through the fixing portion, thus it is convenient for users to use. Further, the massage portion may be driven to rotate/swing to stimulate the sensitive part, such as the G-spot, the prostate, and etc., in which the massage portion is inserted, helping the users reach orgasm quickly.

### BRIEF DESCRIPTION OF THE DRAWINGS

In order to illustrate the technical solution in embodiments of the present application more clearly, the following briefly introduces accompanying drawings used in the description of the embodiments. Obviously, the accompanying drawings in the following description are only some embodiments of the present application. Those of ordinary skill in the art can obtain other accompanying drawings from these accompanying drawings without any creative efforts.

FIG. 1 is an isometric, assembled view of a massage device according to an embodiment of the present application.

FIG. 2 shows the massage device of FIG. 1 from another aspect.

FIG. 3 is a top plan view of the massage device of FIG. 1.

FIG. 4 is a cross-sectional view of the massage device taken along line A-A of FIG. 3.

FIG. 5 is a schematic view of a massage device according to another embodiment of the present application.

Reference numbers in the drawings: 100, massage device; 10, main body; 11, first body; 12, second body; 20, driving mechanism; 21, driving motor; 22, motor housing; 23, control board; 24, battery; 25, second frame; 26, second vibration motor; 30, massage portion; 40, swinging mechanism; 41, swinging rod; 411, first rod body; 412, second rod body; 42, first frame; 43, first vibration motor; 50, fixing portion; 51, first fixing ring; 52, second fixing ring; 53, first connecting portion; 54, second connecting portion; and 60, auxiliary fixing ring.

### DESCRIPTION OF THE EMBODIMENTS

In order to make those skilled in the art better understand the technical solution of the present application, the technical solution in the embodiments of the present application will be clearly and completely described below with reference to accompanying drawings in the embodiments of the present application. Obviously, the described embodiments are only a part of the embodiments of the present application, but not all of the embodiments. Based on the embodiments of the present application, all other embodiments obtained by those skilled in the art without any creative efforts fall within the protection scope of the present application.

It should be noted that when an element is said to be "connected" to another element, it may be directly connected to another element, or indirectly connected to another element through one or multiple intermediate elements.

In the specification, the oriental or positional relationships indicated by the terms “longitudinal”, “transverse”, “top”, “bottom”, “inner”, “outer”, “central”, “axial”, ”radial”, “circumferential” and the like are only intended to facilitate the description of the present application and simplify the description based on oriental or positional relationships shown in the accompanying drawings, not to indicate or imply that the apparatus or element referred must have a specific orientation, is constructed and operated in a specific orientation, and therefore cannot be understood as a limitation of the present application.

Unless otherwise specified and limited, the specific meanings of all technical and scientific terms used in the specification can be specifically understood by persons of ordinary skill in the art. The terms used in the specification of this application is for the purpose of describing specific embodiments only and is not intended to limit this application.

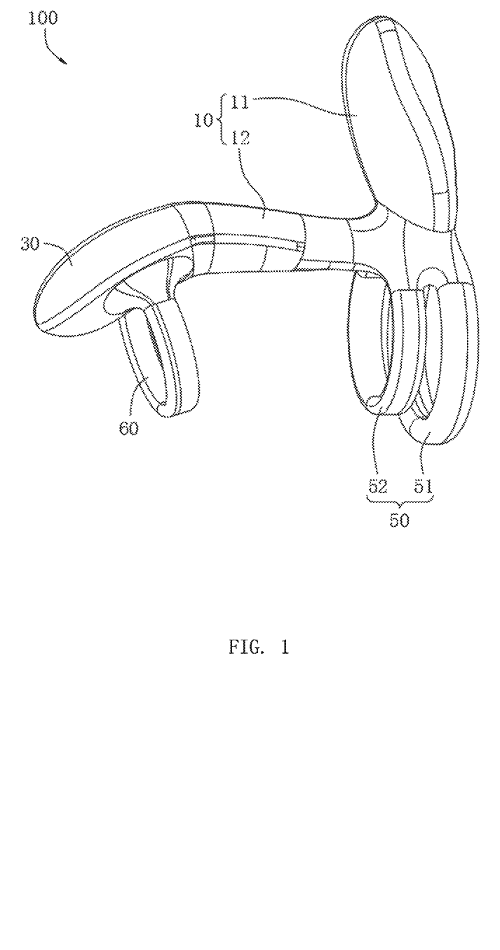

Referring to FIGS. 1-4, a massage device 100 according to an embodiment of the present application is shown. In this embodiment, the massage device 100 includes a main body 10, a driving mechanism 20, a massage portion 30, a swinging mechanism 40, and a fixing portion 50.

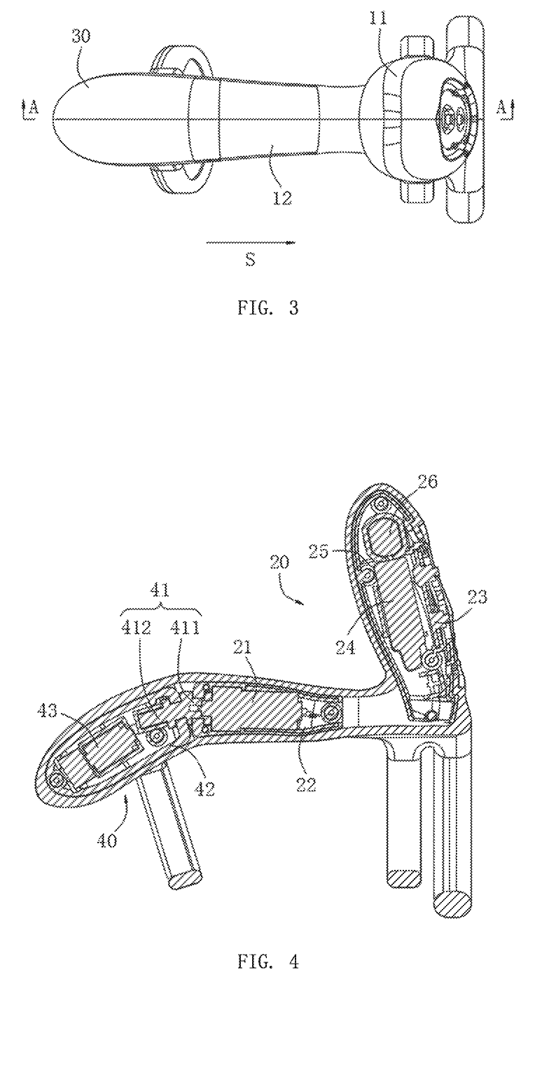

As shown in FIG. 4, the massage portion 30 is provided at an end of the main body 10, configured to be inserted into a human body during use. The fixing portion 50 is provided at another end of the main body 10, configured for positioning the massage device 100 onto the human body. The massage portion 30 and the fixing portion 50 are made of flexible materials, such as silicone, offering a soft and plush texture.

The driving mechanism 20 is set in the main body 10, and the swinging mechanism 40 is set in the massage portion 30 and connected to the driving mechanism 20 in a transmission manner. In this embodiment, the swinging mechanism 40 is mainly used to drive the massage portion 30 to rotate/swing, so as to knead and stimulate a part of the human body in which the massage portion 30 is inserted.

During use, the massage device 100 may be positioned onto the penis of a top partner through its fixing portion 50. The penis, together with the massage portion 30, may be inserted into the vagina or the rectum of a bottom partner. When the driving mechanism 20 is activated, the swinging mechanism 40 is driven to rotate/swing, which in turn drives the massage portion 30 to rotate/swing, thereby providing clitoral and G-spot stimulation or prostate stimulation for the bottom partner.

Further, the fixing portion 50 on the penis may enhance the firmness of the erection and delay ejaculation, increasing the intensity of orgasm for the top partner. That is, the massage device 100 caters to the pleasure of both partners, greatly improving the experience of sexual life. Furthermore, the fixing portion 50 allows users to use their hands to caress their partners instead of holding the massage device, further improving the experience of sexual life.

In addition, for the present massage device 100, the driving mechanism 20, the massage portion 30, the swinging mechanism 40, and the fixing portion 50 are respectively assembled to the main body 10 to form a structurally reasonable and compact device, which is small in volume and light in weight. Thus, the massage device 100 can be positioned on the penis for a long time to effectively assist in penile erection.

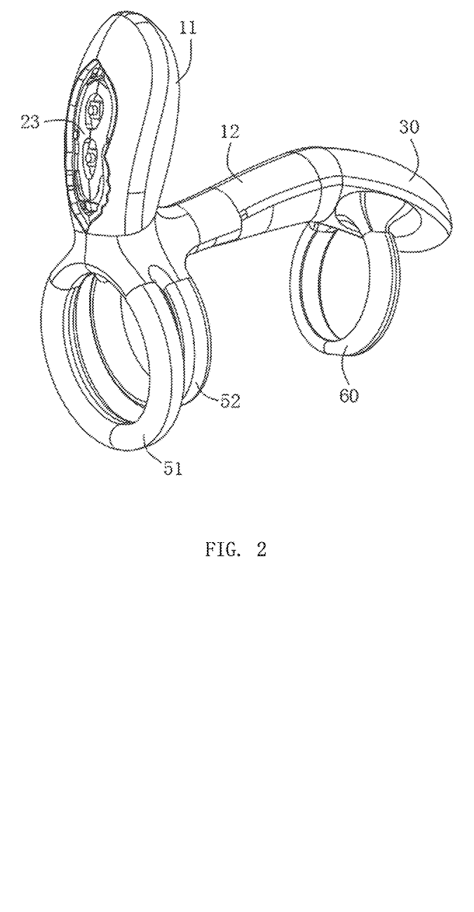

Referring to FIG. 1 and FIG. 2, in an embodiment, the main body 10 includes a first body 11 and a second body 12 being angled with each other, wherein an angle defined between the first body 11 and the second body 12 is greater than 45 degrees, preferably greater than 60 degrees, and more preferably close to 90 degrees. That is, the main body 10 in whole is generally L-shaped.

The massage portion 30 is provided at an end of the second body 12 away from the first body 11. The fixing portion 50 extends from a connecting position of the first body 11 and the second body 12 along a direction generally opposite to the first body 11. That is, the fixing portion 50 and the massage portion 30 are configured at two opposite ends of the second body 12, respectively; and the fixing portion 50 and the first body 11 are configured at two opposite sides, such as bottom and top sides, of the second body 12, respectively.

It should be understood that the penis has a certain length, the fixing portion 50 set away from the massage portion 30 can facilitate the mounting of the massage device 100 onto the root of penis. After assembly, the massage portion 30 is effectively in contact with the penis, and thus the massage portion 30 and the penis both can be inserted into the vagina. Further, the first body 11 may act as another massage portion of the massage device 100, contacting and stimulating the clitoris.

In one embodiment, the fixing portion 50 is configured as a fixing ring. When in use, the fixing ring can be mounted around the root of penis, making it convenient and quick to install the massage device 100 onto the human body. Since the first body 11 and the fixing ring are located at opposite sides of the second body 12, the fixing ring will not interfere with the penis during use.

Referring to FIG. 1 to Fig.2, the fixing portion 50 is preferably configured with two fixing rings, namely a first fixing ring 51 and a second fixing ring 52. The first fixing ring 51 and second fixing ring 52 are arranged side by side at intervals along an insertion direction of the massage portion 30 into the human body, as indicated by the arrow S shown in FIG. 3. In

this embodiment, the insertion direction of the massage portion 30 is generally a longitudinal direction of the second body 12.

In this embodiment, the second fixing ring 52 is closer to the massage portion 30 than the first fixing ring 51, and the penis extends through the first fixing ring 51 and then the second fixing ring 52. Finally, the two fixing rings 51, 52 can secure both the testicles and the penis, thereby providing better support, train the penis, lock in sperm and extend pleasure. Preferably, an inner size/diameter of the first fixing ring 51 is larger than that of the second fixing ring 52.

Furthermore, the massage device 100 may include an auxiliary fixing ring 60 extending from the massage portion 30. The auxiliary fixing ring 60 is preferably made of flexible material, such as silicone. Preferably, the three rings 51, 52, 60 are arranged at the same side, such as bottom side, of the second body 12. When the massage device 100 is mounted onto the penis, the anterior end of penis is supported by the auxiliary fixing ring 60, so as to better support the penis for quick penetration without worrying about slippage and misalignment.

Generally, a length of the second body 12 is less than that of the penis, so that the glans of the penis is exposed when the massage device 100 is fixed onto the penis, which ensures that the same pleasure is retained during penetration, feeling each other's temperature and shape, leading to a better sexual experience. The second body 12 overlaps on the penis increases the girth of the penis while the three rings, 51, 52, 53 restrict blood flow to help erections last longer and harder.

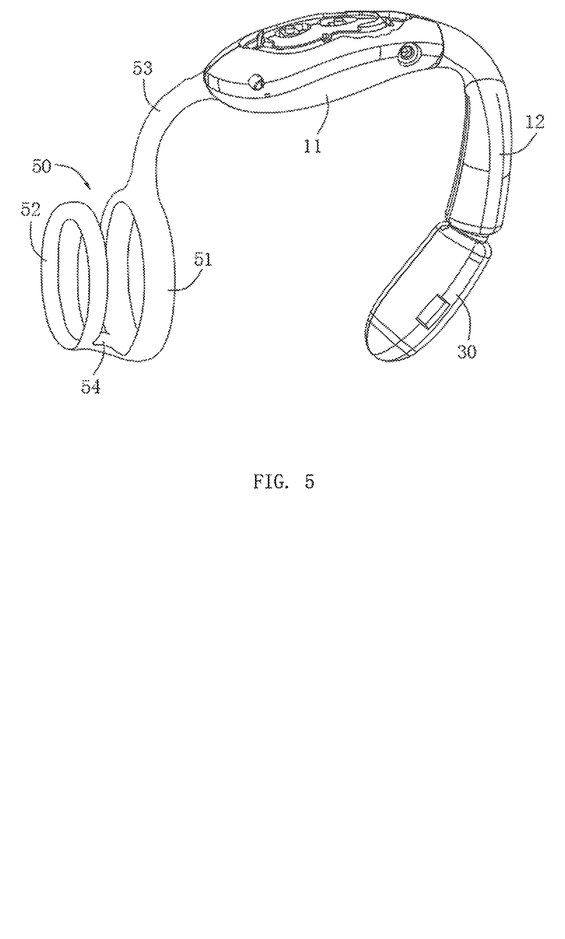

Referring to FIG. 5, in an alternative embodiment, the main body 10 includes a first body 11 and a second body 12 being angled with each other. The massage portion 30 is provided at an end of the second body 12 away from the first body 11. Differently, in this embodiment, the fixing portion 50 is provided at an end of the first body 11 away from the second body 12, and includes a first fixing ring 51 and a second fixing ring 52 arranged side by side in a longitudinal direction of the first body 11.

The massage portion 30 and the fixing portion 50 are arranged on the same side, such as the bottom side, of the first body 11, and the fixing portion 50 is opposite to the massage portion 30 along the longitudinal direction of the first body 11. When the massage device 100 of this embodiment is mounted onto the penis of the user through the fixing rings 51, 52, the massage portion 30 may be inserted into the rectum for stimulating the prostate of the user.

In this embodiment, the first fixing ring 51 is connected to the first body 11 through a first connecting portion 53, and the second fixing ring 52 is connected to the first fixing ring 51 through a second connecting portion 54. Preferably, the first connecting portion 53 and second connecting portion 54 are made of soft material, such as silicon. Preferably, the first fixing ring 51, second fixing ring 52, first connecting portion 53 and second connecting portion 54 are integrally formed as one piece.

In this embodiment, the first connecting portion 53 is elongated and cordlike, making the first fixing ring 51 be easy to adjust its position, so that it is convenient to mount the fixing portion 50 onto the penis. The second connecting portion 54 is short, making the second fixing ring 52 being adjacent to and spaced from the first fixing ring 51. After assembly, the testicles may be positioned between the first fixing ring 51 and second fixing ring 52.

Referring to FIG. 4, the driving mechanism 20 includes a driving motor 21, and the swinging mechanism 40 includes a swinging rod 41. The swinging rod 41 is arranged inside the massage portion 30 and connected to a driving shaft of the driving motor 21 in a transmission way. When in use, the driving shaft of the driving motor 21 drives the swinging rod 41 to rotate/swing about a rotary axis, which in turn drives the massage portion 30 to rotate/swing periodically.

The driving mechanism 20 may further include a motor housing 22 fixed inside the second body 12, and the driving motor 21 is mounted inside and supported by the motor housing 22. The swinging mechanism 40 may further include a first frame 42 being mounted inside and providing support for the massage portion 30. Preferably, a first vibration motor 43 is accommodated inside the first frame 42.

As shown in FIG. 4, the swinging rod 41 includes a first rod body 411 and a second rod body 412 being angled with the first rod body 411. The first rod body 411 is connected to the driving shaft of the driving motor 21, wherein a central axis of the first rod body 411 is collinear with the rotary axis. The second rod body 412 extends from the first rod body 411 into the first frame 42, wherein a central axis of the second rod body 412 is inclined with respect to the rotary axis.

Due to the angled connection between the first rod body 411 and the second rod body 412, when the driving motor 21 is started, the first rod body 411 is driven to rotate about its central axis, while the second rod body 412 is driven to revolve around the rotary axis. Thus, a motion trajectory of the second rod body 412 is conical, and a motion trajectory of an end of the second rod body 412 away from the first rod body 411 is generally circular.

Finally, the first frame 42, which is connected to the second rod body 412, the first vibration motor 43, which is inside the first frame 42, and the massage portion 30, which is fixed around the first frame 42, rotate/swing with the second rod body 412 around the rotary axis, stimulating the human body. During the revolving of the massage portion 30, the first vibration motor 43 may generate high frequency vibration to further stimulate the human body.

Furthermore, the massage device 100 may include a second vibration motor 26 accommodated inside first body 11. When the first body 11 is attached to the human body, such as the clitoris, the second vibration motor 26 may generate high frequency vibration to further stimulate the clitoris. In an embodiment, the massage device 100 may further include a second frame 25 being mounted inside and providing support for the first body 11, wherein the second vibration motor 26 is fixed inside the second frame 25.

Referring to FIG. 4, in an embodiment, the massage device 100 may further include a control board 23 and a battery 24 fixed inside the second frame 25, respectively. The battery 24 is used to provide electric power, and electrically connected to the driving motor 21, the first vibration motor 43 and the second vibration motor 26 through the control board 23. The control board 23 is used to control the operation of the massage device 100, such as control the rotary speed and/or direction of the driving motor 21, control the vibration frequency and/or amplitude of the first vibration motor 43 and/or second vibration motor 26.

Finally, it should be noted that: the above merely describes preferred embodiments of the present application without intention to limit the scope of the present application. Although the present application has been described in detail with reference to the foregoing embodiments, for those skilled in the art, the technical solutions described in the foregoing embodiments can still be modified, or some of the technical features can be equally replaced. Any modifications, equivalent replacements, improvements, and etc. made within the spirit and principle of the present application should be within the scope of the present application.

What is claimed is:

1. A massage device, comprising:
a main body;
a massage portion being provided at an end of the main body, the massage portion being configured to be inserted into a human body;
a driving mechanism being mounted in the main body, configured for driving the massage portion to rotate/swing, so as to stimulate a part of the human body in which the massage portion is inserted; and
a fixing portion extending from the main body, configured for positioning the massage device onto a penis of another human body.

2. The massage device according to claim 1, wherein the main body comprises a first body and a second body being angled with each other, and the massage portion is provided at an end of the second body away from the first body.

3. The massage device according to claim 2, wherein the first body and the second body are substantially perpendicular to each other.

4. The massage device according to claim 2, wherein the fixing portion is provided at a connecting position of the first body and the second body, and the first body and the fixing portion are located at two opposite sides of the second body, respectively.

5. The massage device according to claim 4, further comprising an auxiliary fixing portion extending from the massage portion, and the fixing portion and the auxiliary fixing portion are arranged at the same side of the second body.

6. The massage device according to claim 5, wherein the auxiliary fixing portion is a ring for extending of the penis therethrough.

7. The massage device according to claim 2, wherein the fixing portion is provided at an end of the first body away from the second body.

8. The massage device according to claim 7, wherein an elongated connecting portion is provided between the fixing portion and the first body, and the connecting portion is configured to be flexible for adjusting a position of the fixing portion.

9. The massage device according to claim 2, wherein a vibration motor is accommodated inside the first body; and/or, a vibration motor is accommodated inside the massage portion.

10. The massage device according to claim 1, wherein the fixing portion includes a first fixing ring and a second fixing ring being arranged side by side along an insertion direction of the massage portion into the human body, and an inner size of the first fixing ring is different from that of the second fixing ring.

11. The massage device according to claim 1, wherein the driving mechanism comprises a driving motor arranged in the main body, a swinging rod comprising a first rod body being connected to the driving motor in a transmission way and a second rod body being inclined with respect to the first rod body, and a frame provided inside the massage portion and fixedly connected to the second rod body.

12. A massage device comprising:
a main body;
a driving mechanism mounted in the main body;
a flexible massage portion connected to an end of the main body;
a swinging mechanism mounted in the flexible massage portion and connected to the driving mechanism in a transmission way, the swinging mechanism being configured for driving the flexible massage portion to swing/rotate; and
a flexible fixing portion connected to another end of the main body.

13. The massage device according to claim 12, wherein the main body comprises a first body and a second body being angled with each other, the flexible massage portion is connected to an end of the second body away from the first body, and the flexible fixing portion is connected to a connecting position of the first body and the second body.

14. The massage device according to claim 13, further comprising an auxiliary fixing ring extending from the flexible massage portion.

15. The massage device according to claim 13, wherein the flexible fixing portion and the first body are arranged at two opposite sides of the second body, and a vibration motor is arranged in the first body.

16. The massage device according to claim 12, wherein the main body comprises a first body and a second body being angled with each other, the flexible massage portion is connected to an end of the second body away from the first body, and the flexible fixing portion is connected to an end of the first body away from the second body.

17. The massage device according to claim 16, wherein a flexible connecting portion is provided between the flexible fixing portion and the first body.

18. The massage device according to claim 12, wherein a vibration motor is arranged inside the flexible massage portion.

19. The massage device according to claim 12, wherein the driving mechanism comprises a driving motor mounted inside the main body, and the swinging mechanism comprises a frame mounted inside the flexible massage portion and a swinging rod connected between the driving motor and the frame.

20. The massage device according to claim 19, wherein the swinging rod comprises a first rod body and a second rod body being inclined with respect to the first rod body, the first rod body is connected to a driving shaft of the driving motor, and the second rod body is connected to the frame.
